(19) United States
(12) Patent Application Publication
(10) Pub. No.: US 2006/0228608 A1
(43) Pub. Date: Oct. 12, 2006

(54) High temperature and low relative humidity polymer/inorganic composite membranes for proton exchange membrane fuel cells

(76) Inventors: Tze-Chiang Chung, State College, PA (US); Sridhar Komarneni, Port Matilda, PA (US); Elena Chalkova, State College, PA (US); Serguei Lvov, Bellefonte, PA (US)

Correspondence Address: Julie K. Staple;Gifford, Krass, Groh, Sprinkle,, Anderson & Citkowski, P.C., P.O. Box 7021, Troy, MI, 48007-7021, US

(21) Appl. No.: 11/400,865

(22) Filed: Apr. 10, 2006

Related U.S. Application Data
(60) Provisional application No. 60/670,186, filed on Apr. 11, 2005.

(51) Int. Cl. H01M 8/10

(52) U.S. Cl. 429/33; 429/316

(57) ABSTRACT

PEMFCs based on perfluorinated ionomer membranes (such as NAFION) are limited to temperatures below 100° C. because of the critical dependence of NAFION conductivity on the stability of liquid water. Ion-conductive composite compositions provided by the present invention, ion exchange membranes including such composite compositions and fuel cells incorporating those membranes are capable of maintaining high conductivity and mechanical integrity when temperature is above 100° C.

### REFERENCE TO RELATED APPLICATION

This application claims priority of U.S. Provisional Patent Application Ser. No. 60/670,186 filed Apr. 11, 2005, the entire content of which is incorporated herein by reference.

### FIELD OF THE INVENTION

This invention relates generally to ion conductive materials. More specifically, the invention relates to organic polymer/inorganic composite materials, as well as articles such as ion conducting membranes and proton exchange membrane fuel cells incorporating such materials.

### BACKGROUND OF THE INVENTION

Throughout the industrial age and into the information age, energy has served as the foundation for human progress. One of the major challenges and concerns for the future relates to the safety and availability of an energy supply. Currently, our primary sources of energy are fossil fuels, namely oil, natural gas, and coal. Since these materials are nonrenewable and exhaustible, some reports predict that demand for these resources will exceed supply within the foreseeable future.

In addition to supply limitations, future use of fossil fuels invokes concerns regarding unacceptable environmental impacts and health concerns. Carbon dioxide from energy production now contributes a large portion of the greenhouse gas emissions in the United States. Because the effect of carbon dioxide release is cumulative, the need to find alternative energy sources is becoming increasingly compelling. In addition to greenhouse gas emission due to production of fossil fuels, the combustion of fossil fuels by electric power plants, vehicles, and other sources is responsible for most of the smog particulates in the air, which cause respiratory disease.

Recent advances in developing hydrogen-based energy systems show great promise as a long-term solution for a secure energy future. Hydrogen fuel cells are significantly more energy efficient than combustion-based power generation technologies. A conventional combustion-based power plant typically generates electricity at efficiencies of 33-35 percent, while fuel cell plants can generate electricity at efficiencies of up to 60 percent. Further, when fuel cells are used to generate electricity and heat (co-generation), they can reach efficiencies of up to 85 percent. Examples relating to transportation further illustrate this difference, since internal combustion engines in today's automobiles convert less than 30 percent of the energy in gasoline into power that moves the vehicle. Vehicles using electric motors powered by hydrogen fuel cells are much more energy efficient, utilizing 40-60 percent of the fuel's energy.

Hydrogen based proton exchange membrane fuel cells (PEMFC) are considered an important future technology. These fuel cells have the advantage of using hydrogen, oxygen and water to operate, without requiring volatile organic compounds or corrosive substances. A typical PEMFC includes a polymer electrolyte membrane, or proton exchange membrane, (PEM), positioned between an anode and a cathode. Hydrogen used for fuel is directed to the anode where a platinum catalyst causes the hydrogen to split into protons and electrons. The PEM allows only protons to pass through it to the cathode, and the generated electrons may be routed by an external circuit to the cathode, creating an electrical current. Protons and oxygen combine to form water.

PEM fuel cells are used in numerous applications such as powering a vehicle small-scale stationary power generation, or portable device, such as cellular phones and portable electronics, for example.

A significant barrier to current PEM technology is the reliance of existing PEM membrane properties on the availability of free water. Most of the existing membranes, including the current commercial standard, NAFION (DuPont), require water as a vehicle for proton transfer. The intensive volatilization of water at temperatures above 100° Ce causes a significant decrease in proton conductivity and, in some cases irreversible phase transformation or destruction of the membrane. Thus the operation of present day PEMFCs based on perfluorinated ionomer membranes (such as NAFION) are limited to temperatures below 100° C. because of the critical dependence of NAFION conductivity on the stability of liquid water. However, operation of PEMFCs at temperatures above 100° C. is an attractive target from the standpoint of cost and efficiency, since it helps to solve such fundamental technological problems as catalysis of anode reaction, anode poisoning, and cathode flooding.

Thus, there is a continuing need for ion-conductive compositions, proton exchange membranes and fuel cells incorporating those membranes which are capable of maintaining high conductivity and mechanical integrity when water vapor pressure is severely reduced.

### SUMMARY OF THE INVENTION

An ion-conducting composite composition is provided according to the present invention which includes a body of an organic substantially non-ion conductive polymer and a plurality of inorganic ion-conductive particles.

Broadly, an included organic substantially non-ion conductive fluoropolymer has the formula:

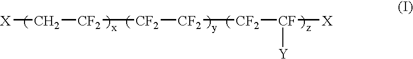

where each X is independently SiR₁R₂R₃, hydrogen, halogen, CH═CF₂, or CF═CF₂, where R₁, R₂, and R₃ are each independently H, halogen, or a C₁-C₁₀ substituted or unsubstituted, saturated or unsaturated, linear, branched, alkyl, alkoxyl, cyclic alkyl or aryl group, and where at least one X is SiR₁R₂R₃. Y is a functional group and x is between 50 mole % and 100 mole %; y is between 0 mole % to about 50 mole %; z is between 0 mole % and 30 mole %. The combined x+y+z mole % is 100%.

In a further embodiment, a polymer such as shown at (I) includes a polymer where each Y is independently selected from among OH; halogen; ester; epoxy; thiol; COOH; SO₃H; O—Si-iR₁R₂R; Si(OH)₃; PO(OH)₂; a pyrimidine salt; an olefinic group; and SiR₁R₂R₃; where R₁, R₂, and R₃ are each independently H, halogen, or a C₁-C₁₀ substituted or unsubstituted, saturated or unsaturated, linear, branched, alkyl, alkoxyl, cyclic alkyl or aryl group.

In one embodiment of an inventive ion-conducting composition the organic substantially non-ion conductive polymer includes a fluropolymer. In a specific embodiment, an included fluoropolymer has the formula (II):

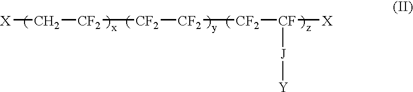

where each X is independently SiR₁R₂R₃, or hydrogen, where R₁, R₂, and R₃ are each independently H, halogen, or a C₁-C₁₀ substituted or unsubstituted, saturated or unsaturated, linear, branched, alkyl, alkoxyl, cyclic alkyl or aryl group. In a preferred embodiment, each polymer chain (II) contains at least one X which is an SiR₁R₂R₃ group.

Y is a functional group, illustratively including OH, halogen, ester, epoxy, thiol, COOH, SO₃H, O—Si—R₁R₂R₃, Si(OH)₃, PO(OH)₂, a pyrimidine salt, an olefinic group, and SiR₁R₂R₃, where R₁, R₂, and R₃ are each independently H, halogen, or a C₁-C₁₀ substituted or unsubstituted, saturated or unsaturated, linear, branched, alkyl, alkoxyl, cyclic alkyl or aryl group.

J is an optional connecting group, preferably a divalent hydrocarbon or perfluorinated C₀ to C₁₀ group with linear or branched structure.

In the illustrated structure (II), x is between 50 mole % and 100 mole %, preferably x is between 60 and 99 mole %, and most preferably x is between 80 and 95 mole %; y is between 0 mole % to about 50 mole %, preferably y is between 0 and 40 mole %, and most preferably y is between 0 and 30 mole %; z is between 0 mole % and 30 mole %, preferably z is between 0 and 20 mole %, and most preferably z is between 0 and 15 mole %; and the combined x+y+z mole % is 100%. In a preferred embodiment the polymer molecular weight is in the range of about 1,000 to 50,000 g mol⁻¹, more preferably in the range between 2,000 to 25,000 g mol⁻¹, and yet more preferably in the range of about 3,000 to 10,000 g mol⁻¹.

A fluoropolymer included in an inventive composition may be a mixture of fluoropolymers, each having identical or differing terminal groups X, functional groups Y and/or connecting groups J.

Also described is an embodiment of a composition according to the present invention in which the plurality of inorganic ion-conductive particles includes a crystalline inorganic material. Such a crystalline inorganic material may be a layer-structured phase of a hydrogen phosphate, a three-dimensional network phase of a hydrogen phosphate, a porous titanosilicate, or a combination thereof.

Optionally, an ion-conducting composition includes a plurality of inorganic ion-conductive particles which include an amorphous inorganic material. For example, an included amorphous inorganic material may be a mesoporous oxide, a microporous oxide, a glass, a hybrid sol/gel, or a combination thereof.

In one embodiment, the plurality of inorganic ion-conductive particles includes three-dimensional H₃OZr₂(PO₄)₃.

In general, the plurality of inorganic ion-conductive particles is present in an inventive composite composition in an amount in the range of about 10 to 99 percent of the composition by weight.

An ion conducting membrane is provided according to the present invention which includes a body of an organic substantially non-ion conductive polymer and a plurality of inorganic ion-conductive particles.

Further described is a membrane electrode assembly including an ion conducting membrane provided by the present invention.

A fuel cell including a composition, membrane and/or membrane electrode assembly according to the present invention is also provided.

### BRIEF DESCRIPTION OF THE DRAWING

FIG. 1 is a graph showing proton conductivity of a composite membrane according to the invention compared with a recast NAFION in water membrane, as a function of temperature.

### DETAILED DESCRIPTION OF THE INVENTION

Ion conductive composite materials are provided which include an inorganic proton conductor and a polymer which is substantially non-ion conductive. In preferred embodiments, proton conductive composite materials are provided which include an inorganic proton conductor and a polymer which is substantially non-proton conductive. Membranes incorporating a composite composition according to the present invention are also provided, along with fuel cell assemblies incorporating such membranes.

In one embodiment a composite composition according to the present invention includes a hydrophobic polymeric material and a proton conducting, hygroscopic, inorganic material.

A composite composition includes an amount of an ion-conductive inorganic material in the range of about 10 to 99 percent, inclusive, by weight of the total weight of the composition. In preferred embodiments the inorganic material is present in an amount in the range of about 20 to 80, inclusive, percent by weight of the total weight of the composition. In further preferred embodiments the inorganic material is present in an amount in the range of about 30 to 70, inclusive, percent by weight of the total weight of the composition.

Additional preferred compositions include an amount of an ion-conductive inorganic material in the range of about 40 to 99 percent, inclusive, 50 to 90 percent, inclusive, and 55-80 percent, inclusive.

A ratio of an inorganic proton conductor to a polymer which is substantially non-ion conductive in an inventive composite is in the range of about 100:1-1:5, inclusive, by weight. In preferred embodiments, such a ratio is in the range of about 10:1-1:4, inclusive by weight. In further preferred embodiments, such a ratio is in the range of about 5:1-1:3, inclusive by weight.

Inorganic Material

Broadly, a proton conducting inorganic compound includes a compound of a group IVa or IVb element. Group IVa elements include titanium, zirconium, hafnium and thorium. Group IVb elements include carbon, silicon, germanium, tin and lead. Preferred elements are titanium, zirconium and tin. An inorganic material included in a composite composition according to the present invention is a proton conducting material which is hygroscopic and capable of retaining water, in the form of a hydrate, an adsorbate, or the like. Oxides and phosphates are general classes of materials which may be utilized in a composition according to the present invention.

In a specific embodiment an ion-conductive inorganic component of a composite material includes an ion-conductive crystalline material. Preferred crystalline materials include layer structured phases of hydrogen phosphates, three-dimensional network phases of hydrogen phosphates, and porous titanosilicates. In one particular group of embodiments described herein, the inorganic material includes a zirconium phosphate, a tin phosphate and/or a titanium phosphate. In a further specific embodiment, the inorganic material includes H₃OZr₂(PO₄)₃ in a three-dimensional network phase.

Particular layer structured phases of hydrogen phosphates included in a composite composition according to the present invention include α-Zr-phosphate, α-Zr(HPO₄)₂.H₂O; γ-Zr-phosphate; γ-Zr(HPO₄)₂.2H₂O; α-Ti-phosphate; α-Ti(HPO₄)₂.H₂O; γ-Ti-phosphate; γ-Ti(HPO₄)₂.2H₂O; α-Sn-phosphate; α-Sn(HPO₄)₂.H₂O. Layered structured hydrogen phosphates have protons attached to the PO₄ tetrahedra in the interlayers and surrounded by water molecules. These layered phases have extremely high proton contents, about 7 meq/g. Such layered phases may be synthesized by conventional and microwave hydrothermal processes such as described in Komarneni, S., et al., J. Mat. Chem., 4:1903, 1994.

Exemplary ion-conductive three-dimensional network phases of hydrogen phosphates may be included in an inventive composite composition as an ion conductive inorganic component. In three-dimensional network hydrogen phosphates, protons occupy positions typically occupied by sodium cations in the so-called “NZP” structure described in Goodenough, J. B. et al., Mat. Res. Bull., 11:203, 1976. Three-dimensional network hydrogen phosphates having protons occupying positions typically occupied by sodium cations have the general formula H₁₋₄B₂(PO₄)₃ where B is a trivalent and or tetravalent metal. Tetravalent metals illustratively include Zr, Ti, Sn, and Hf. Optionally, a tetravalent non-metal, such as Si or Ge may be used. Compounds where B is a tetravalent metal illustratively include HZr₂(PO₄)₃; H(Zr₂₋ₓSnₓ)(PO₄)₃; HTi₂(PO₄)₃; H₃OTi₂(PO₄)₃. These materials retain water up to 300° C., have very small pore size and are hydrophilic as described in Clearfield, A. et al., Mat. Res. Bull., 19:219, 1984. Proton content of such compounds can be further increased to reach higher conductivity via specific chemical substitutions of a trivalent metal may be substituted for a tetravalent metal. Exemplary trivalent metals include Co³⁺, Fe³⁺, Al³⁺, Cr³⁺, In³⁺, Ga³⁺, and La³⁺.

Three-dimensional network phases of hydrogen phosphates may be synthesized as described in Clearfield et al., Mat. Res. Bull., 19:219, 1984, for instance.

Exemplary porous titanosilicates include Na₂Ti₂O₃SiO₄.2H₂O and H₂Ti₂O₃SiO₄.1.5H₂O. These materials are structurally analogous to the three-dimensional HZr₂(PO₄)₃ phases but have larger pores in which protons are located. The large pores may facilitate better proton conductivity. These three-dimensional structures may be synthesized by hydrothermal methods such as are described in Poojary, D. M. et al., Inorg. Chem., 35:6131, 1996.

A further class of ion-conductive inorganic materials which may be included in an inventive composite includes amorphous and/or glassy materials. Suitable amorphous and/or glassy materials illustratively include mesoporous oxide materials, microporous oxide materials, glasses and hybrid sol/gel materials.

Ion-conductive mesoporous oxide materials have wormhole-like channels and are very stable at high temperatures. Mesoporous oxide materials include oxides such as alumina (Al₂O₃), titania (TiO₂), and zirconia (ZrO₂). Mesoporous oxide materials may be prepared by methods such as the neutral template method such as described in Tanev, P. T. and Pinnavaia, T. J., Science, 267:865, 1995 and Komarneni, S. et al., J. Porous Mat., 3:99, 1996.

Ion-conductive microporous oxide materials include amorphous silicas and semi-crystalline silicates, such as described in Park et al., J. Materials Research, 15:1437-1440, for example.

In general the inorganic ion conducting material included in a composite composition according to the present invention is provided in a particulate form, and one typical range of particle sizes includes 0.1 to 1.0 microns. Generally, the particulate material has a very high surface area, in the range of 1-200 m²/g as measured by the BET multipoint N₂ surface area analysis technique.

Polymers

As noted, a polymer included in an inventive composite composition is a substantially non-conducting polymer.

In one embodiment a preferred polymer is a fluoropolymer. Further preferred is a fluoropolymer having functional groups for such functions as cross linking and/or interaction with an inorganic component of an inventive composite material.

Broadly described, a functionalized fluropolymer included in an inventive composite composition in one embodiment has the formula: G-( [symbol] ) where G is a functional group and ( [symbol] ) is a symbolic representation of a fluropolymer. In one embodiment, G is one or more terminal functional groups for cross-linking fluoropolymer chains may be included in a functionalized fluropolymer included in an inventive composition. Such a terminal functional group may be a silane group in one embodiment. In one embodiment, a fluoropolymer preferably further includes a functional group for interaction with an inorganic ion-conductive material.

For example, a preferred polymer is a telechelic polymer. In one embodiment, such a telechelic polymer contains one or more functional silane groups at one or more polymer chain ends. Preferred polymers display thermal and chemical stability within a target temperature range of about −30 to about 120° C.

Broadly, an included organic substantially non-ion conductive fluoropolymer has the formula:

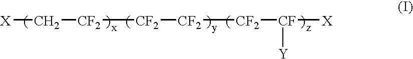

where each X is independently SiR₁R₂R₃, hydrogen, halogen, CH═CF₂, or CF═CF₂, where R₁, R₂, and R₃ are each independently H, halogen, or a C₁-C₁₀ substituted or unsubstituted, saturated or unsaturated, linear, branched, alkyl, alkoxyl, cyclic alkyl or aryl group, and where at least one X is SiR₁R₂R₃. Y is a functional group and x is between 50 mole % and 100 mole %; y is between 0 mole % to about 50 mole %; z is between 0 mole % and 30 mole %. The combined x+y+z mole % is 100%.

In a further embodiment, a polymer such as shown at (I) includes a polymer where each Y is independently selected from among OH; halogen; ester; epoxy; thiol; COOH; SO₃H; O—Si—R₁R₂R₃; Si(OH)₃; PO(OH)₂; a pyrimidine salt; an olefinic group; and SiR₁R₂R₃; where R₁, R₂, and R₃ are each independently H, halogen, or a C₁-C₁₀ substituted or unsubstituted, saturated or unsaturated, linear, branched, alkyl, alkoxyl, cyclic alkyl or aryl group.

In a specific embodiment, an included fluoropolymer has the formula (II):

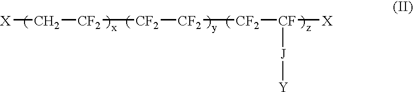

where each X is independently —SiR₁R₂R₃, or hydrogen, where R₁, R₂, and R₃ are each independently H, halogen, or a C₁-C₁₀ substituted or unsubstituted, saturated or unsaturated, linear, branched, alkyl, alkoxyl, cyclic alkyl or aryl group.

In a preferred embodiment, each polymer chain (II) contains at least one X which is an SiR₁R₂R₃ group. Preferred SiR₁R₂R₃ groups are silane cross linkers.

Y is an optional polar functional group preferably included in an included fluoropolymer, illustratively including OH, halogen, ester, epoxy, thiol, COOH, SO₃H, O—Si—R₁R₂R₃, Si(OH)₃, PO(OH)₂, a pyrimidine salt, such as an iodine salt of a pyrimidine, an olefinic group, and SiR₁R₂R₃, where R₁, R₂, and R₃ are each independently H, halogen, or a C₁-C₁₀ substituted or unsubstituted, saturated or unsaturated, linear, branched, alkyl, alkoxyl, cyclic alkyl or aryl group. Such polar functional groups contribute to providing compatibility of the polymer with inorganic elements of the composite material and contribute to maintaining the continuity of proton transfer.

J is an optional connecting group, preferably a divalent hydrocarbon or perfluorinated C₀ to C₁₀ group with linear or branched structure.

In the illustrated structure (II), x is between 50 mole % and 100 mole %, preferably x is between 60 and 99 mole %, and most preferably x is between 80 and 95 mole %; y is between 0 mole % to about 50 mole %, preferably y is between 0 and 40 mole %, and most preferably y is between 0 and 30 mole %; z is between 0 mole % and 30 mole %, preferably z is between 0 and 20 mole %, and most preferably z is between 0 and 15 mole %; and the combined x+y+z mole % is 100%. In a preferred embodiment the polymer molecular weight is in the range of about 1,000 to 50,000 g mol⁻¹, more preferably in the range between 2,000 to 25,000 g mol⁻¹, and yet more preferably in the range of about 3,000 to 10,000 g mol⁻¹.

A fluoropolymer included in an inventive composition may be a mixture of polymer units (I) having identical or differing terminal groups X, functional groups Y and/or connecting groups J.

In one embodiment, a preferred polymer includes the structure:
(H₅C₂O)₃Si [symbol] CH₂—CF₂ [symbol] ₓ(CF₂—CF₂ [symbol] _{y}Si(OC₂H₅)₃ (III)

The telechelic polymer structure (III) shown contains silane cross linkers (Si(OR₃)) at two polymer chain ends. Such silane cross linkers contribute to providing a stable 3-D polymer network.

A polar functional group Y may be incorporated in a side chain of a polymer included in an inventive composite material, such as illustrated at (III). Y is an optional polar functional group preferably included in an included fluoropolymer, illustratively including OH, halogen, ester, epoxy, thiol, COOH, SO₃H, O—Si—R₁R₂R₃, Si(OH)₃, PO(OH)₂, PO(O R₁)₂, a pyrimidine salt, such as an iodine salt of a pyrimidine, an olefinic group, and SiR₁R₂R₃, where R₁, R₂, and R₃ are each independently H, halogen, or a C₁-C₁₀ substituted or unsubstituted, saturated or unsaturated, linear, branched, alkyl, alkoxyl, cyclic alkyl or aryl group.

J is an optional connecting group which may be included in a polymer such as illustrated at (III). J is preferably a divalent hydrocarbon or perfluorinated C₀ to C₁₀ group with linear or branched structure.

In the copolymer structure,
(H₅C₂O)₃Si [symbol] CH₂—CF₂ [symbol] ₓ(CF₂—CF₂ [symbol] _{y}Si(OC₂H₅)₃ (III)

x is between 50 mole % and 100 mole %, preferably x is between 60 and 99 mole %, and most preferably x is between 80 and 95 mole %; y is between 0 mole % to about 50 mole %, preferably y is between 0 and 40 mole %, and most preferably y is between 0 and 30 mole %; z is between 0 mole % and 30 mole %, preferably z is between 0 and 20 mole %, and most preferably x is between 0 and 15 mole %; and the combined x+y+z mole % is 100%. In a preferred embodiment the polymer molecular weight is in the range of about 1,000 to 50,000 g mol⁻¹, more preferably in the range between 2,000 to 25,000 g mol⁻¹, and yet more preferably in the range of about 3,000 to 10,000 g mol⁻¹.

In some embodiments vinylidene fluoride (VDF) units may be introduced into the polymer backbone to increase processability, while still maintaining high thermal and chemical stability of the polymer.

Synthesis of these and further suitable fluoropolymers for inclusion in an inventive composite material include those described in U.S. Pat. No. 6,911,509 and in examples described herein.

An exemplary scheme for synthesis of a fluoropolymer included in an inventive composition is shown in Scheme 1. This exemplary polymerization scheme illustrates preparation of telechelic Teflon-based polymer by combination of functional borane initiator containing a silane terminal group and functional co-monomers.

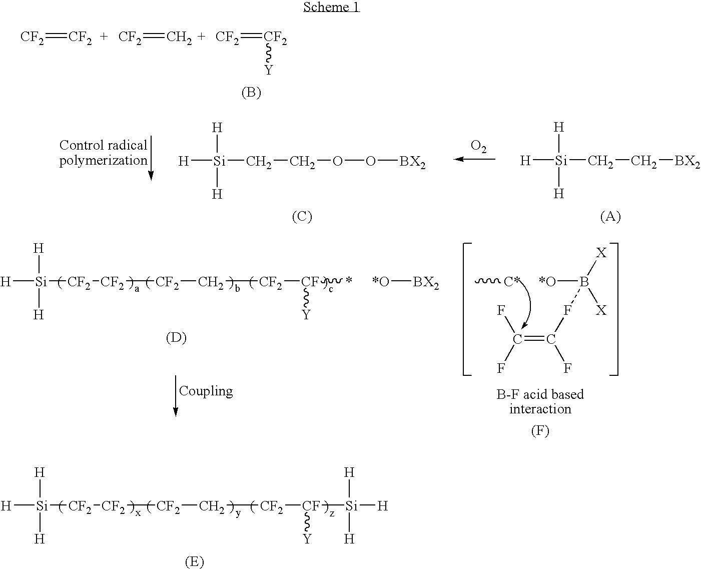

In addition, several exemplary synthetic schemes for further fluoropolymers suitable for use in an inventive composition are illustrated below:

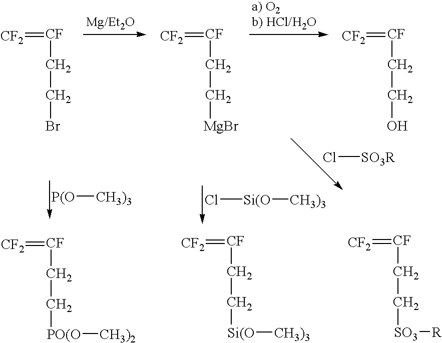

In a further particular embodiment, an inventive composite composition includes an organic non-ion conducting polymer having a general chemical formula (RO)₃Si(CF₂CH₂)ₓin which each R is independently H or an alkyl group. Preferably, each R is independently H or a C₁-C₁₀ substituted or unsubstituted, saturated or unsaturated, linear, branched, cyclic alkyl and/or aryl, and most preferably each R is independently H or C₁ alkyl. The average number of repeating vinylidene difluoride units (x) in the main chain is between about 100 and 100,000. Preferably, x is between about 200 and about 10,000, and most preferably x is between about 400 and 5,000.

A substantially non-ion conducting polymer included in a composition according to the present invention is typically characterized by an ion-conductivity of 1×10⁻⁵ S/cm or less. Further, a substantially non-ion conducting polymer has an ion-conductivity of 1×10⁻³ S/cm or less in a further embodiment. In still further embodiments a substantially non-ion conducting polymer has an ion-conductivity of 1×10⁻⁵ S/cm or less.

In preferred embodiments, a polymer included in an inventive composition is a non-proton conducting polymer characterized by a proton-conductivity of 1×10⁻² S/cm or less. A substantially non-proton conducting polymer has a proton conductivity of 1×10⁻³ S/cm or less in a further embodiment. In still further embodiments a substantially non-proton conducting polymer has a proton-conductivity of 1×10⁻⁵ S/cm or less.

Membranes

An ion-conducting membrane, also known as an ion exchange membrane, according to the present invention includes a composite composition including an ion-conducting inorganic material and a substantially non-ion conductive polymer.

An ion exchange membrane according to the present invention includes an amount of an ion-conductive inorganic material in the range of about 10 to 99 percent, inclusive, by weight of the total weight of the membrane. In preferred embodiments the inorganic material is present in an amount in the range of about 20 to 80, inclusive, percent by weight of the total weight of the membrane. In further preferred embodiments the inorganic material is present in an amount in the range of about 30 to 70, inclusive, percent by weight of the total weight of the membrane.

Additional preferred compositions include an amount of an ion-conductive inorganic material in the range of about 40 to 99 percent, inclusive, 50 to 90 percent, inclusive, and 55-80 percent, inclusive.

Membranes including such relatively high weight percentages of ion conductive inorganic particles have advantages of increased chemical inertness and resistance to wide temperature fluctuation which is especially important in thermal cycling.

A ratio of an inorganic proton conductor to a polymer which is substantially non-ion conductive in an inventive composite is in the range of about 100:1-1:5, inclusive, by weight. In preferred embodiments, such a ratio is in the range of about 10:1-1:4, inclusive by weight. In further preferred embodiments, such a ratio is in the range of about 5:1-1:3, inclusive by weight.

In preferred embodiments, an inventive membrane is composed primarily of an inventive composite composition including an ion-conducting inorganic material and a substantially non-ion conducting polymer. Thus, a preferred embodiment of inventive membrane is composed of about 90-100% of an inventive composite composition. Preferred are membranes including about 98-100% of an inventive composite composition.

A membrane including a composite inorganic/polymer composition according to the present invention may be prepared by any of various methods, including for instance, dispersion of inorganic particles in a polymer solution followed by film casting from the suspension, and in situ precipitation of the inorganic phase inside a preformed membrane.

For example, in a method of dispersing inorganic particles in a polymer solution followed by film casting, powders of inorganic materials are blended with an organic solution of polymer or with a liquid low molecular weight polymer precursor. Following ultrasonication and filtration, suspensions are cast to uniform films of desired thickness.

Such membrane preparation techniques are applicable to all presynthesized inorganic materials included in an inventive composition.

In an alternative preparation technique, inorganic nanocolloidal dispersions may be used instead of presynthesized dry solid powders. Such a colloidal dispersion of exfoliated layered materials may be formed in a polymer solvent, using intercalation-deintercalation or other techniques.

In a further method, the in situ precipitation method, a filler precursor is introduced to a preformed polymeric membrane by impregnation or through an ion exchange reaction, followed by treatment of the membrane with required reactants to transform the precursor to an insoluble solid filler inside a membrane. Such a method may be used for in situ formation of layered Zr, Ti, and Sn phosphates inside different polymeric matrices. For example ZrOCl₂, TiOCl₂ and SnOCl₂ may be used as precursors and subsequently converted to insoluble phosphates with phosphoric acid.

For example, in situ formation of a layered Zr phosphate in a polymeric matrix may be accomplished by swelling a membrane including a fluoropolymer as described herein in a boiling methanol-water solution to facilitate ionic diffusion and dipping the swelled membrane into a 1 M solution of zirconyl chloride for six hours at 80 ° C. During this time, Zr⁴⁺ ions exchange with protons in the membrane. After that, the membrane is rinsed thoroughly and placed in 1 M phosphoric acid solution for six hours at 80° C. to precipitate insoluble ZP in situ and to protonate anions to regenerate the membrane's acidity. Similarly, a layered Ti and/or Sn phosphate may be formed in a polymeric membrane. Further details of such a procedure are described in W. G. Grot and G. Rajendran, U.S. Pat. No. 5,919,583 (1999) and C. Yang, S. Srinivasan, A. B. Bocarsly, S. Tulyani, J. B. Benziger, J. Membr. Sci., 237, 145 (2004).

In particular embodiments an inorganic material which is a component of an inventive composite is dispersed throughout the polymer in a composition and/or inventive membrane. In further embodiments, such an inorganic ion conductor material is localized within the membrane, for instance at surface of the membrane. In a further particular embodiment, the inorganic ion conductor material includes particles which associate in the membrane to form a network of particles. The term “associate” includes contact between separate particles.

In one embodiment composite inorganic/polymer membranes may be prepared using a casting procedure that involves direct mixing of a low molecular weight 3-D precursor (Mn=3,000 to 10,000 g mol⁻¹), which has a physical form of a viscous liquid or wax, with inorganic proton conducting particles. The resulting inorganic/polymer suspension may be ultrasonicated to ensure good dispersion of inorganic particles. Such a suspension may be filtered to remove coarse aggregates, and cast to form a uniform film of desired thickness.

Recast films of polymer precursor with inorganic oxides may be cured by use of appropriate coupling agents to form cross-linking sites in the three-dimensional polymer network. Such recast films may be cured by a coupling agent to form cross-linking sites in a 3-D polymer network. Such coupling agents include trienes or dienes in moisture in the case of —SiH₃ and —Si(OR)₃ terminal groups, respectively.

A membrane electrode assembly including a membrane according to the present invention is provided. An embodiment of an inventive membrane electrode assembly includes a polymer electrolyte membrane, or proton exchange membrane, (PEM) according to the present invention positioned between an anode and a cathode.

Compositions according to the present invention are useful in various applications, such as in ion conductive membranes and in membrane electrode assemblies. Such compositions, membranes and membrane electrode assemblies may be used in a PEM fuel cell for instance.

Embodiments of the inventive compositions, membranes, MEAs and methods are illustrated in the following examples as well as herein. These examples are provided for illustrative purposes and are not considered limitations on the scope of the inventive compositions, membranes, MEAs and methods.

### EXAMPLES

### Example 1

In a particular example an inorganic/organic membrane material includes 60 percent by weight of three-dimensional H₃OZr₂(PO₄)₃ and 40 percent functionalized poly(vinylidene fluoride).

A membrane including 60 percent by weight of three-dimensional H₃OZr₂(PO₄)₃ and 40 percent functionalized poly(vinylidene fluoride) is produced in this example by dissolving the polymer in a solvent, adding the three-dimensional H₃OZr₂(PO₄)₃ and mixing the polymer and inorganic component. A mixture is cast and the solvent evaporated to form an ion conducting composite membrane.

Conductivity data for this composite membrane with Si-terminal groups and Si—OH functional groups are measured at elevated temperatures as shown in Table 1.

TABLE 1

| | New composite material: | Recast |
|---|---|---|
| | inorganic/organic membrane material | Nafion ®: |
| | (60% 3-dimensional H₃OZr₂(PO₄)₃ + 40% | Proton |
| Temperature, | functionalized poly[vinylidene fluoride]) | conductivity |
| ° C. | Proton conductivity (S cm⁻¹) | (S cm⁻¹) |
| 120 | 0.07 | 0.17 |
| 140 | 0.1 | 0.1 |

The conductivity measurements shown in this table are performed in water by electrochemical impedance spectroscopy techniques using a four electrode cell and a Gamry Instruments electrochemical test station as described in Zhou, X. Y. et al., Electrochim. Acta, 48:2173, 2003. Note that, first, at 120° C. the composite membrane conductivity of 0.07 S cm⁻¹ is more than four orders of magnitude higher than the conductivity of H₃OZr₂(PO₄)₃ in a pellet (3×10⁻⁷ S cm⁻¹). See Subramanin, M. A. et al., Mat. Res. Bull., 19:1471, 1984. Second, in contrast to NAFION, the composite membrane conductivity continues to grow as the temperature increases from 120 to 140° C. The membrane is chemically stable in the high temperature aqueous environment, and its mechanical properties are appropriate for making a uniform thin film suitable for a membrane electrode assembly preparation. The water uptake, swelling of the inventive composite membrane material described is measured as the increase in membrane weight after equilibration with water, is found to be very low compared to NAFION in Table 2.

TABLE 2

| | Water uptake, wt. % | |
|---|---|---|
| | Composite material: | |
| | inorganic/organic membrane material | |
| Temperature, | (60% 3-dimensional H₃OZr₂(PO₄)₃ and 40% | Recast |
| ° C. | functionalized poly[vinylidene fluoride]) | Nafion ®: |
| 23 | 0.9 | 28 |
| 100 | 1.1 | 27 |

The fact that the membrane shows a high conductivity at such low water content implies that the transport properties of this material have minimal dependence on the availability of free water.

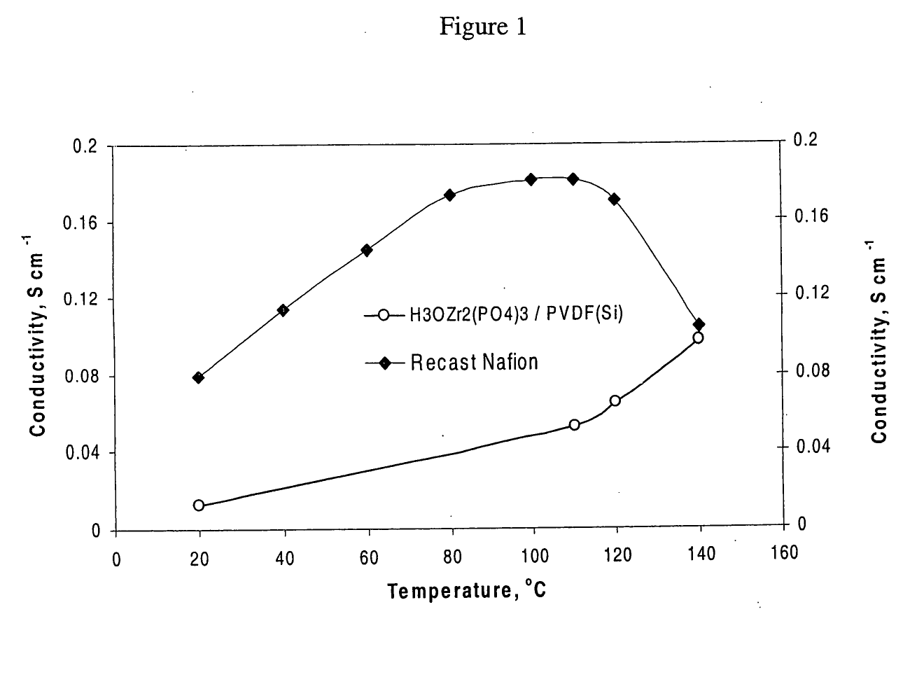

FIG. 1 shows proton conductivity of an inventive composite membrane compared to recast NAFION in water as a function of temperature.

Any patents or publications mentioned in the specification incorporated herein by reference to the same extent as if each individual publication is specifically and individually indicated to be incorporated by reference. In particular, U.S. Patent Application No. 60/670,186 filed Apr. 11, 2005 is hereby incorporated by reference in its entirety. The compositions, membranes, MEAs, fuel cells and methods described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

1. An ion-conducting composition, comprising:
a body of an organic substantially non-ion conductive fluoropolymer; and
a plurality of inorganic ion-conductive particles.

2. The ion-conducting composition of claim 1 wherein the organic substantially non-ion conductive fluoropolymer has the formula: 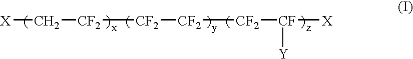
where each X is independently SiR₁R₂R₃, hydrogen, halogen, CH═CF2, or CF═CF2, where R₁, R₂, and R₃ are each independently H, halogen, or a C₁-C₁₀ substituted or unsubstituted, saturated or unsaturated, linear, branched, alkyl, alkoxyl, cyclic alkyl or aryl group, and where at least one X is SiR₁R₂R₃; where Y is a functional group; x is between 50 mole % and 100 mole %; y is between 0 mole % to about 50 mole %; z is between 0 mole % and 30 mole %; and the combined x+y+z mole % is 100%.

3. The composition of claim 2 where each Y is independently selected from the group consisting of: OH; halogen; ester; epoxy; thiol; COOH; SO₃H; O—Si—R₁R₂R₃; Si(OH)₃; PO(OH)₂; a pyrimidine salt; an olefinic group; and SiR₁R₂R₃; where R₁, R₂, and R₃ are each independently H, halogen, or a C₁-C₁₀ substituted or unsubstituted, saturated or unsaturated, linear, branched, alkyl, alkoxyl, cyclic alkyl or aryl group.

4. The composition of claim 2 further comprising a connecting group J such that the organic substantially non-ion conductive fluoropolymer has the formula:

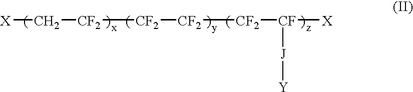

5. The composition of claim 4 wherein each connecting group J is independently selected from the group consisting of: a divalent hydrocarbon, and a perfluorinated C₀ to C₁₀ group with linear or branched structure.

6. The ion-conducting composition of claim 1 wherein the plurality of inorganic ion-conductive particles comprises a crystalline inorganic material.

7. The ion-conducting composition of claim 3 wherein the crystalline inorganic material is selected from the group consisting of: a layer-structured phase of a hydrogen phosphate, a three-dimensional network phase of a hydrogen phosphate, a porous titanosilicate, and a combination thereof.

8. The ion-conducting composition of claim 4 wherein the layer-structured phase of a hydrogen phosphate is selected from the group consisting of: a layer-structured phase of a Group IVa hydrogen phosphate, a layer-structured phase of a Group IVb hydrogen phosphate, and a combination thereof.

9. The ion-conducting composition of claim 4 wherein the layer-structured phase of a hydrogen phosphate is selected from the group consisting of: α-Zr-phosphate, α-Zr(HPO₄)₂.H₂O; γ-Zr-phosphate; γ-Zr(HPO₄)₂.2H₂O; α-Ti-phosphate; α-Ti(HPO₄)₂.H₂O; γ-Ti-phosphate; γ-Ti(HPO₄)₂.2H₂O; α-Sn-phosphate; α-Sn(HPO₄)₂.H₂O and a combination thereof.

10. The ion conducting composition of claim 4 wherein the three-dimensional network phase of a hydrogen phosphate is selected from the group consisting of: a three-dimensional network phase of a Group IVa hydrogen phosphate, a three-dimensional network phase of a Group IVb hydrogen phosphate, and a combination thereof.

11. The ion conducting composition of claim 7 wherein the three-dimensional network phase of a hydrogen phosphate has the formula H₁₋₄B₂(PO₄)₃, where B is selected from the group consisting of: a trivalent metal, a tetravalent metal, Si, Ge, and a combination thereof.

12. The ion conducting composition of claim 4 wherein the porous titanosilicate is selected from the group consisting of: Na₂Ti₂O₃SiO₄.2H₂O, H₂Ti₂O₃SiO₄.1.5H₂O, and a combination thereof.

13. The ion-conducting composition of claim 1 wherein the plurality of inorganic ion-conductive particles comprises an amorphous inorganic material.

14. The ion-conducting composition of claim 10 wherein the amorphous inorganic material is selected from the group consisting of: a mesoporous oxide, a microporous oxide, a glass, a hybrid sol/gel, and a combination thereof.

15. The ion-conducting composition of claim 1 wherein the plurality of inorganic ion-conductive particles comprises a semi-crystalline material.

16. The ion-conducting composition of claim 1 wherein the plurality of inorganic ion-conductive particles comprises three-dimensional H₃OZr₂(PO₄)₃.

17. The composition of claim 1 wherein the plurality of inorganic ion-conductive particles are present in an amount in the range of about 10 to 99 percent of the composition by weight.

18. An ion conducting membrane comprising a composition according to claim 1.

19. A membrane electrode assembly comprising the ion conducting membrane of claim 18.

20. A fuel cell comprising the composition of claim 1.
